(19) United States
(12) Patent Application Publication
(10) Pub. No.: US 2005/0149527 A1
(43) Pub. Date: Jul. 7, 2005

(54) System and method for uniquely identifying persons

(75) Inventors: Donald M. Berlin, Arlington, VA (US); William S. Lofgren, Lexington, VA (US)

Correspondence Address: STAAS & HALSEY LLP, SUITE 700, 1201 NEW YORK AVENUE, N.W., WASHINGTON, DC, 20005, US

(73) Assignee: Intellipoint International, LLC, Washington, DC (US)

(21) Appl. No.: 10/748,196

(22) Filed: Dec. 31, 2003

(51) Int. Cl. G06F 7/00

(52) U.S. Cl. 707/9

(57) ABSTRACT

A system that determines whether a non-uniquely identified name substantially corresponds to a uniquely identified person. A source dataset of uniquely identified persons is accessed, where the source dataset has records including, for each uniquely identified person, a source name, a source unique identifier, a source date of birth, and a source address. A target dataset of non-uniquely identified persons is also accessed, where the target dataset has records that include, for each non-uniquely identified person, a target name, and either (1) a target age and a target age-date indicating an exact or approximate date of the target age, or (2) a target address. For a particular source person in the source dataset, whether the particular source person corresponds to a particular target person in the target dataset is determined automatically in accordance with the accessing.

### BACKGROUND OF THE INVENTION

1. Field of the Invention

The present invention is directed to the field of data searching. More particularly, the present invention relates to uniquely identifying a person when only minimal information about a person is available, such as a name and age, or a name and address, as located in one database source, and comparing that data in a separate source which has different datasets to thereby match one against the other.

2. Description of the Related Art

In April 2003, to restore investor confidence, various brokerage and finance firms agreed with state and federal regulators to comply with a Voluntary Initial Public Offering (IPO) Agreement. The Agreement may be found at www.sec.gov/news/press/globalvolinit.htm (as of October, 2003). Under the Agreement, participating firms agreed to implement reasonable procedures to ensure that they do not allocate “hot” IPO securities to the accounts of officers and directors of qualified publicly traded companies. The firms also agreed not to allocate such securities to the accounts of immediate family members of officers and directors of publicly traded companies.

However, it is difficult to determine whether any person, including an account holder, is an officer or director of a publicly traded company. There is no listing of uniquely identified (e.g. by social security number) officers and directors. In the past, determining whether a name and age or name and address correspond to a particular individual has required manual investigation. What is needed is a system and method that will allow participating firms to automatically identify, with reasonable certainty, an account holder or customer, or immediate family member thereof, as an officer or director of a publicly traded company based on non-uniquely identified names of such officers and directors and based on information of the population at-large of which the account holder is a member.

### SUMMARY OF THE INVENTION

It is an aspect of the present invention to provide a system and method to determine with reasonable certainty the true identify of a non-uniquely identified name and age or name and address.

It is another aspect of the present invention to provide a system to automatically determine which accounts of a firm are held by an officer or director of a publicly traded company.

It is yet another aspect of the present invention to combine various disparate sources of public records into a combined public records dataset, and to use the public records dataset to help uniquely identify an individual corresponding to a non-unique name, or to identify immediate family members or cohabitants corresponding to the non-unique name.

It is still another aspect of the present invention to combine various sets of Security and Exchange Commission (SEC) records to obtain a list of non-uniquely identified names, and one or more of an associated address and age.

It is a further aspect of the present invention to determine whether a named individual customer of a firm corresponds to a record of an officer or director of a publicly traded company based on a measure of how unique the individual customer's name is.

It is another aspect of the present invention to match a name and age/address with a uniquely identified individual, when the name does not have an associated identifier or other indicia of uniqueness such as a social security number.

It is yet another aspect of the present invention to provide a system that combines records of the public at large to find sets of addresses of uniquely identified persons, and which determines whether a person is related to an officer or director of a publicly traded company by referring to the sets of common historical addresses.

The above aspects can be attained by a system and method that determines whether a non-uniquely identified name substantially corresponds to a uniquely identified person. A source dataset of uniquely identified persons is accessed, where the source dataset has records including, for each uniquely identified person, a source name, a source unique identifier, a source date of birth, and a source address. A target dataset of non-uniquely identified persons is also accessed, where the target dataset has records that include, for each non-uniquely identified person, a target name, and either (1) a target age and a target age-date indicating an exact or approximate date of which the target age was recorded, or (2) a target address. For a particular source person in the source dataset, whether the particular source person corresponds to a particular target person in the target dataset is determined automatically in accordance with the accessing.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a generic system that may be used for matching uniquely identified account holders (firm customers) with weakly-identified names of officers and directors of publicly traded companies.

FIG. 2 shows an overall process for matching all account holders or customers when some officers and directors are uniquely identified.

FIG. 3 shows aggregated datasets.

FIGS. 4A-4F show tables/files of insider trading information and business records 100, 104, 108, 112, 116, and 120 that are preferably used as the SEC data sources 58.

FIG. 5 shows a process for processing a list of well-identified names against weakly or non-uniquely identified names.

FIG. 6 shows an example of address matching.

FIG. 7 shows an example of name-uniqueness matching 146.

FIG. 8 shows one of many possible hardware configurations that may be used to implement embodiments of the present invention.

### DETAILED DESCRIPTION OF THE PREFERRED EMBODIMENTS

Overview: Need to Identify Restricted Traders

As discussed in the “Background of the Invention”, it is difficult to identify whether a well-identified person is an officer or director of a publicly traded company. Put another way, participating firms are charged with the difficult task of knowing whether the “Chris Smith” associated with a particular well-identified account is the same “Chris Smith” who is an officer or director of a publicly traded company, when there may be many people named “Chris Smith” in the at-large population. Despite significant need to identify such people, automated identification of an officer or director has not previously been accomplished.

A firm participating in the IPO Agreement mentioned in the “Background of the Invention” manages investment accounts for their customers. An account may have securities owned by the account holder. The firm's customer, who is the holder of the account, may be well identified to the firm. For example, for each account, the firm may have the account holder's social security number or equivalent. This is a unique number, which, if accurate, uniquely identifies the real-world persona of the holder of the account. Although an investment firm may have a high level of confidence that the identity of an account holder is correct, that unique identity is difficult to match to a bare list of names, such as of officers and directors, with only weak or non-unique associated identity information such as age, address, etc. Furthermore, such a list of named officers and directors is not readily available, and must be pieced together using data synthesis tools and algorithms that sift through hundreds of databases to come up with a match.

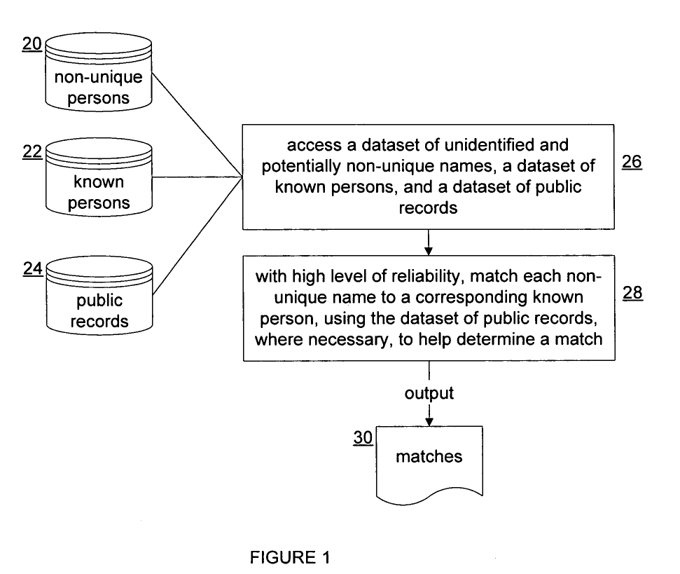

FIG. 1 shows a system for matching uniquely identified account holders (firm customers) with weakly-identified names of officers and directors of publicly traded companies. In general, a dataset of unidentified and potentially non-unique names 20 (e.g. names of officers and directors), a dataset of known persons 22 (e.g. firm customer list), and a dataset of public records 24 are provided for access 26. Then, preferably using a multi-stage matching or elimination process, non-unique names in the non-unique name dataset 20 are matched with or eliminated using unique names in the dataset of known persons 22 and using the public records 24 to help identify matches 30.

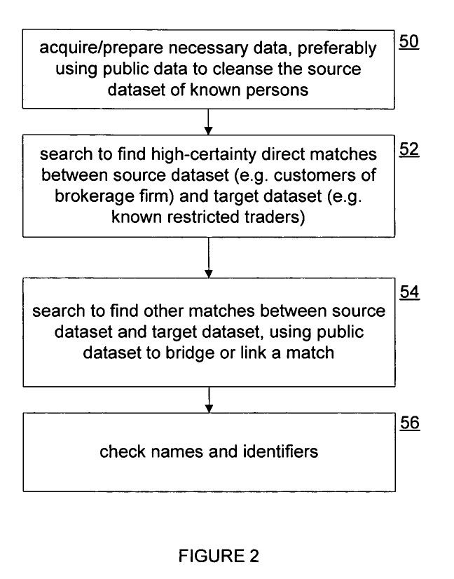

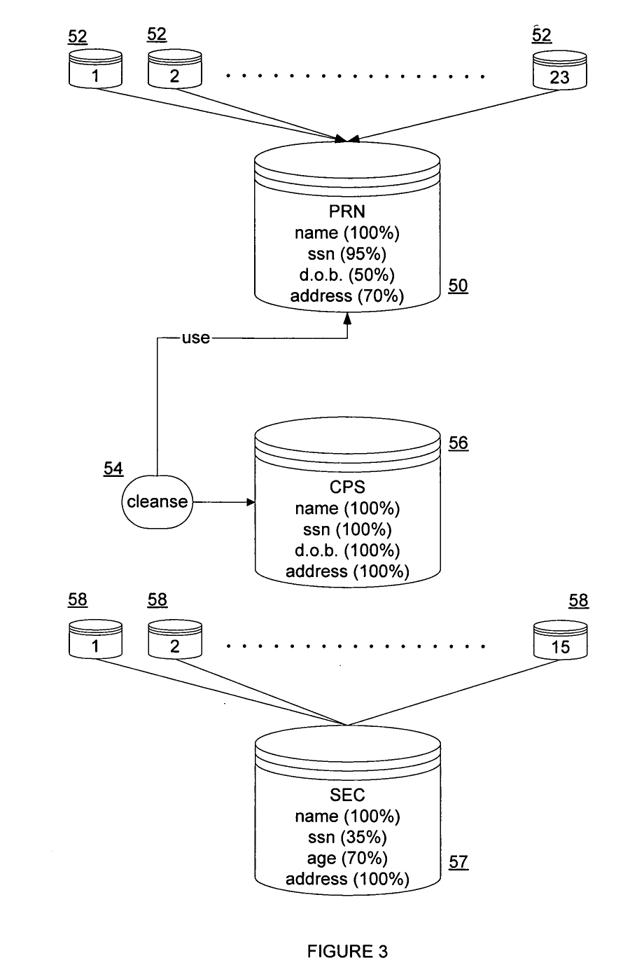

FIG. 2 shows an overall process for matching all account holders or customers when some officers and directors are uniquely identified, as for example by SSN. As seen in FIG. 3 (discussed later), approximately 35% of the relevant SEC records provide a related social security number (SSN), however, such information comes from an information data provider that has not verified the correctness of the data being reported to them on SEC forms 3, 4, 5 and 144. Typically, the data provider will not have verified that the self-confessed information placed on the form is correct, and the data provider will not have verified that the SSN is for the exact name of the person that it has been assigned to by the SSA and many other variables. Therefore, in an overall process for determining which account holders are officers or directors, an initial step, after acquiring 50 the datasets 20, 22, and 24, is to search 52 for the high-certainty matches. That is to say, names of officers and directors in dataset 20 that have an associated SSN are matched with records in the uniquely identified dataset 22 that have a matching name and SSN (or only a matching SSN). The overall process continues with a search 54 to find matches where SSN is not available, by using the dataset of public records 24 to link the non-unique names with the unique names. Finally, the names and identifiers may be crosschecked 56 for further assurance.

Preparing and Acquiring the Data

FIG. 3 shows aggregated datasets. The public records dataset 24/50 is preferably the first dataset that is obtained or accessed. In a preferred embodiment, a set of 23 public record data sources 52 are combined into one public records network (PRN) dataset 50. The public data sources 52 are referred to as “public” because they generally contain records of information of a public provenance or of publicly conducted transactions. The public data sources 52 may in practice be public, private, proprietary, or restricted-access databases. Although most of the data sources 52 can be obtained commercially, some data sources 52 can only be obtained en masse under certain legal conditions (restricted access). The PRN dataset 50 will contain many instances of like-named people within the subject at-large population. This is one reason why name matching is difficult; the name of a weakly identified officer or director can potentially correspond to one of many different like-named individuals in the at-large population. One skilled in the art will appreciate the similarity of the records of some individuals in a statistically large population (e.g. millions of people).

Examples of possible data sources 52 include, but not are not limited to: 1—data of birth, 2—driver's license, including name and address, 3—alias or also-known-as names, 4—other SSNs, 5—other names associated with an SSN, 6—addresses associated with a subject, 7—real property ownership, 8—deed transfers, 9—vehicles registered at subjects' addresses, 10—watercraft, 11—FAA aircraft registration, 12—UCC filings, 13—bankruptcies, liens, and judgments, 14—professional licenses, 15—FAA pilot licenses, 16—DEA controlled substance license, 17—business affiliations, 18—relatives of other people who have the same address as the subject, 19—licensed drivers at subject's address, 20—neighborhood phone listings for subject's addresses, 21—banking, financial, and credit relationships, 22—credit report data, that is restricted under FCRA, 23—asset-based records. Of these 23 public data sources 52, sources 1, 3, 4, 5, 6, and 18 are the most significant for the present invention. The public data sources 52 are combined. The public data sources 52 or the combined PRN dataset 50 may be commercially obtained from Thomson Analytics. It is important that the PRN dataset 50 contain names, and where available, SSNs, dates of birth (d.o.b.), and addresses. Typically, by mining and piecing together the public data sources 52, across the records, it is possible to have the SSN for 95% of the subjects, the d.o.b. for 50% of the subjects, and the address for 70% of the subjects. The PRN dataset 50 may contain approximately 20 billion records. There is an assumption that the subjects or names to be matched are within the general population corresponding to the PRN dataset 50, that is to say, the mass of persons whose information is found in the PRN dataset 50.

Preferably, the PRN dataset 50 is used to cleanse 54 the Customer Profile Source (CPS) dataset 56, although other data sources or only algorithms may be used for cleansing 54. Cleansing 54 can involve any number of well-known techniques, including spelling correction, comparison for consistency with public records carrying the same information (e.g. d.o.b.), and so on. Although substantially all CPS dataset 56 records will be populated with a name, SSN, d.o.b., and address, the records are preferably cleansed to improve their accuracy. The SSN and d.o.b. are verified and updated if necessary. All past addresses of the subject ore obtained for the purpose of later checking to obtain the names and identities of spouses or minor children A cleanse code, discussed in the Appendix, can be added to CPS dataset 56 records to indicate a level of quality or reliability of each record.

A weakly identified SEC dataset 57 is obtained by combining various SEC data sources 58, including insider trading information, SEC Form filings, and the like. The SSN will be available in 35% of all cases. The age will be available in 70% of cases. The address will be available in 100% of cases, however the address can, without indication, correspond to a work location, a residential location, and can be either a present or past location of the subject. Preferably, the existence of a record itself is used as the information that indicates that a record's named subject is or was an officer or director of a publicly traded company. As discussed later, the information gaps in the SEC dataset 57 are addressed by using different matching techniques according to the information available for a given subject. The SEC dataset 57 contains records relating to approximately 500,000 individuals. Again, the individuals in the SEC dataset 57 are assumed to be from among the same general population that corresponds to the PRN dataset 50 and the CPS dataset 56. One skilled in the art will appreciate that a population refers to most people inhabiting one or more countries, regions, commonly governed areas, etc.

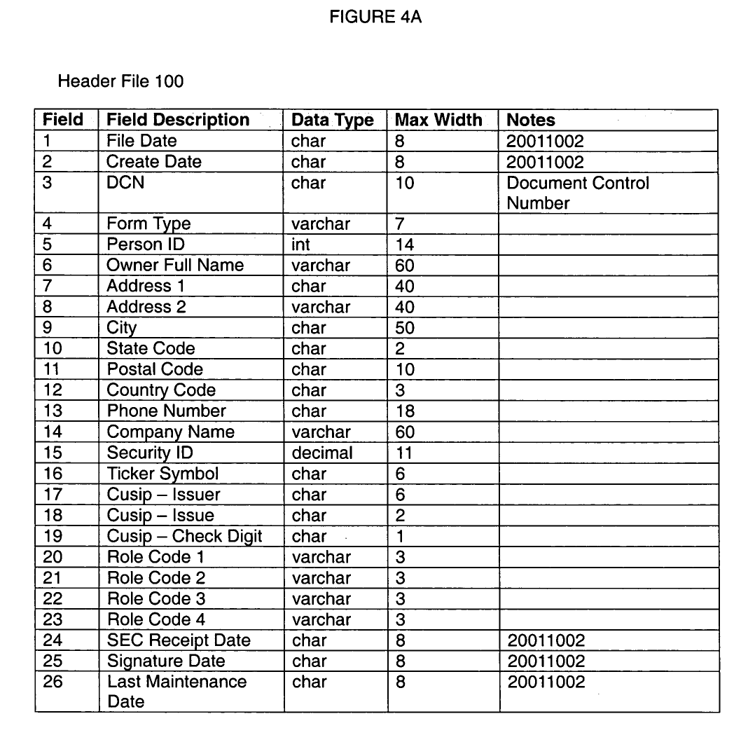

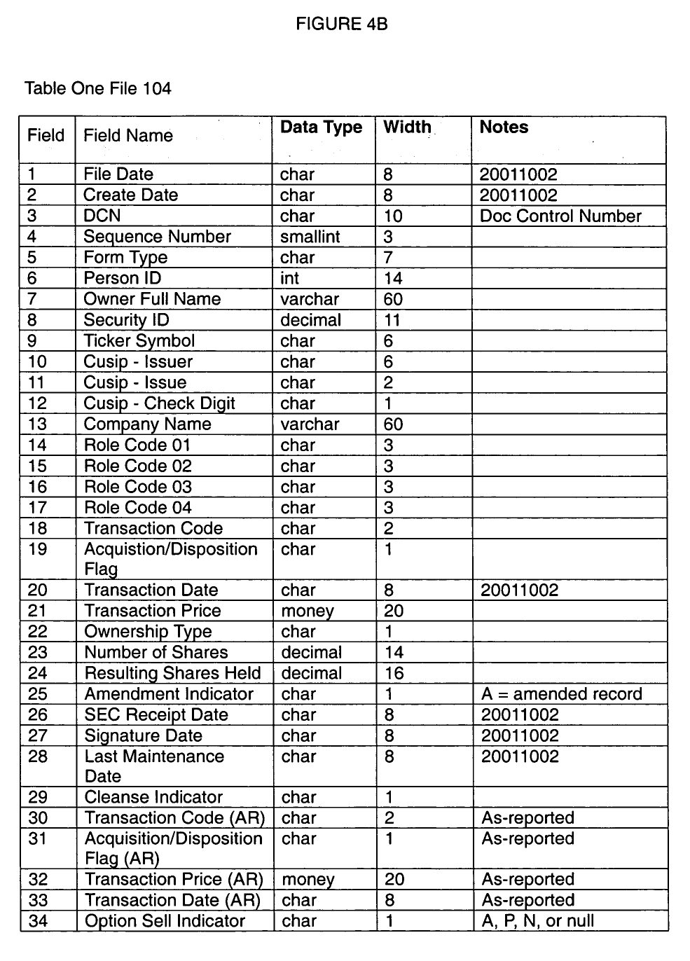

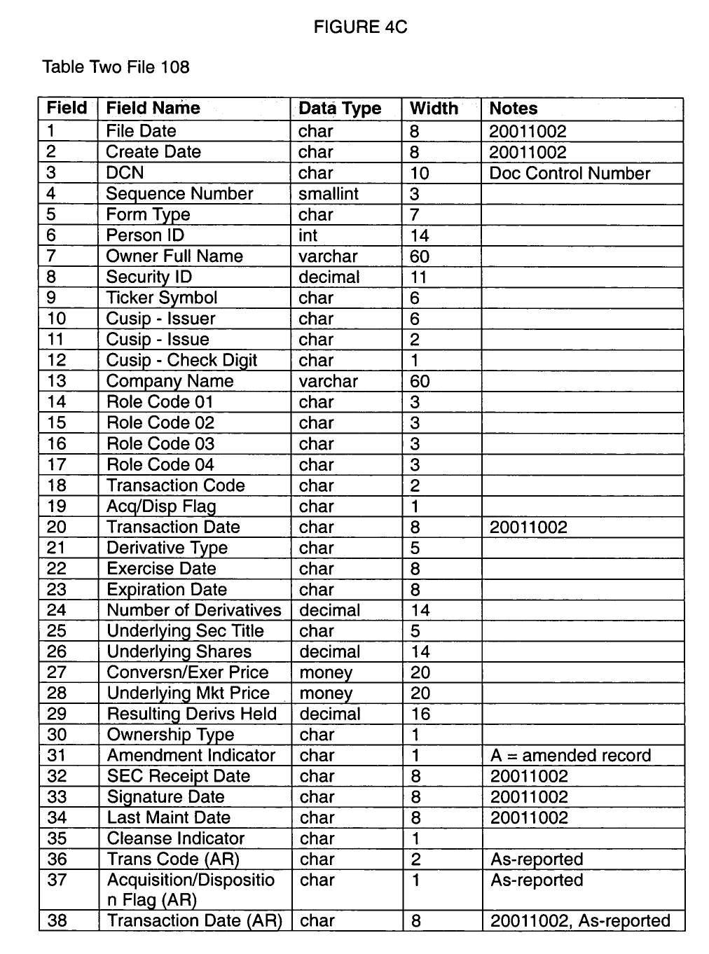

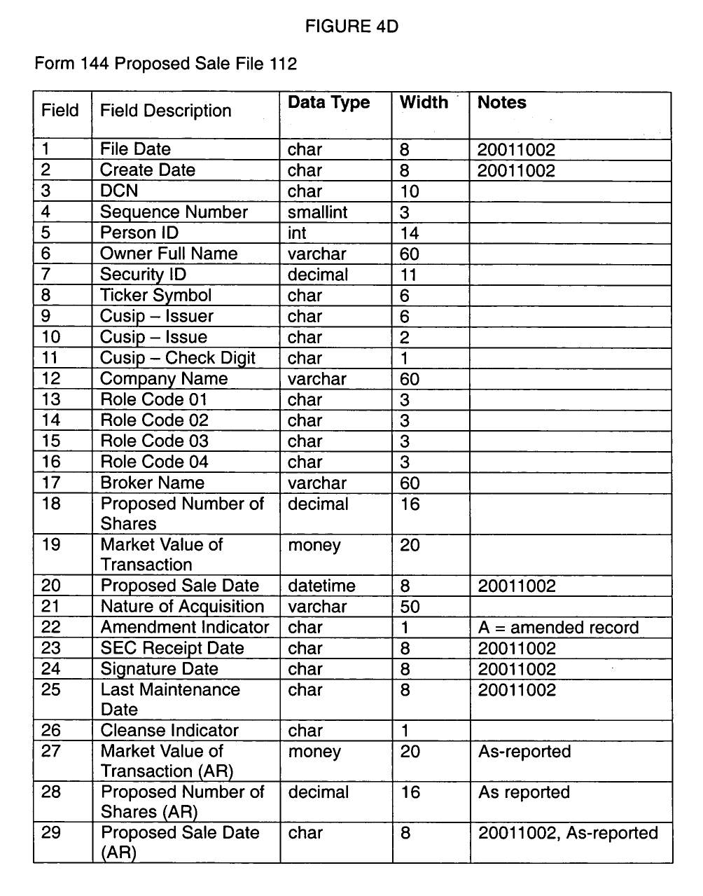

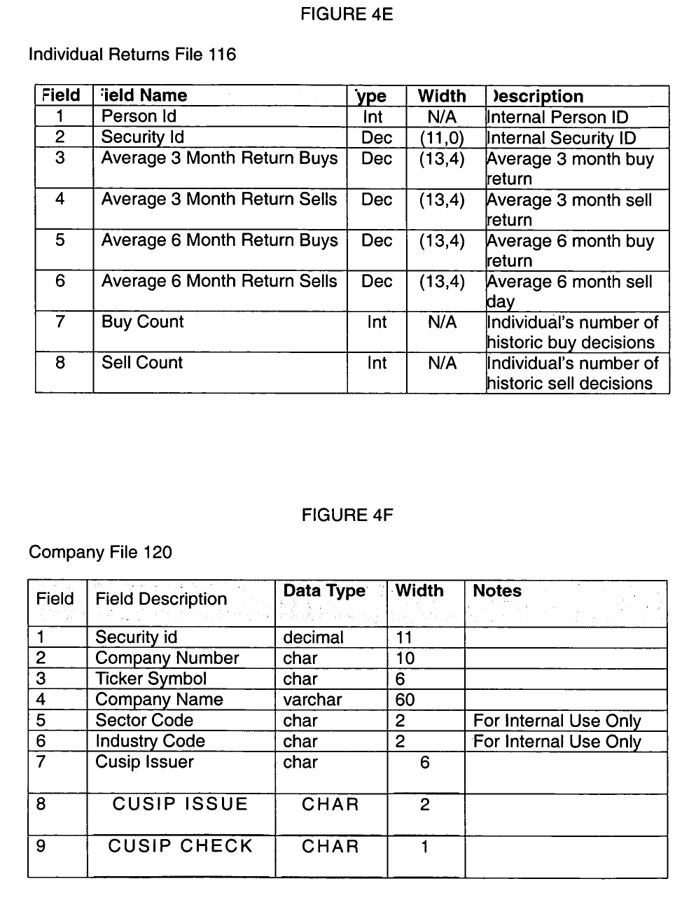

FIGS. 4A-4F show tables/files of insider trading information and business records 100, 104, 108, 112, 116, and 120 that are preferably used as the SEC data sources 58. Such tables are commercially available. The header file 100 shown in FIG. 4A has information included in the header on SEC Forms 3, 4, 5, and 144. The header information can be linked to the transactional files through the Document Control Number (DCN). The header file 100 also captures insider filings with header information only, which is typical of the SEC Form 3. The records of the header file 100 generally span from January 1986 to the present. The header file 100 is the primary indicator of whether a Form's subject was serving in the role of an officer or director.

The table one file 104 shown in FIG. 4B contains most transaction and holdings information filed on SEC Forms 3, 4, and 5. The table one file 104 has several value-added fields including a cleanse indicator that identifies whether the data was cleansed using external data sources, and an indicator of the degree of confidence in each data record. Cleanse indicator codes are described in the Appendix. The records of the table one file 104 also span from January 1986 to the present. Cleansing services may be commercially purchased.

The table two file 108 shown in FIG. 4C contains most transaction and holdings information filed on SEC Forms 3, 4, and 5. The data in the table two file 108 includes open market derivative transactions as well as information on the award, exercise, and expiration of stock options. The records of the table two file 108 generally span from January 1996 to the present.

The Form 144 proposed sale file 112 shown in FIG. 4D is derived from SEC Form 144 filings. This data includes the expected date of sale of securities, the number of securities to be sold, the estimated market value of the proposed sale, and the name of the executing broker. The records of the Form 144 proposed sale file 112 span from June 1996 to the present.

The individual returns file 116 shown in FIG. 4E is derived from SEC Form 144 filings and includes the expected date of sale, the number of securities to be sold, the estimated market value of the proposed sales, and the name of the executing broker. The records of the individual returns file 116 span from June 1996 to the present.

The company information file 120 shown in FIG. 4F provides company specific identifiers including security ID, ticker, company name, sector, and industry. The security ID is the link back to the insider transactions files 100, 104, 108, and the form 144 proposed sale file 112. The records in the company information file span from June 1986 to the present.

Given the datasets 50, 56, and 57 discussed above, it is possible to perform the matching methods discussed below.

Matching Known Persons to Records of Non-Uniquely Identified Records

As discussed above, a purpose of the present invention relates to matching a loosely identified person/name to a well-identified person/name. In the application of identifying former officers or directors for security trading firms, it is noted that because under the Hot IPO Agreement a participating firm need only “reasonably” identify whether an account holder is a restricted trader, it is not necessary to find matches with high certainty. Rather, finding a match that has only a reasonable probability (say 50%) of being correct will satisfy a firm's obligation.

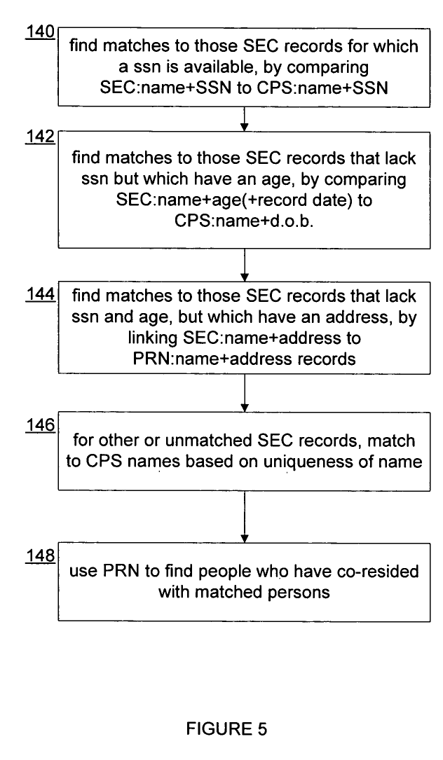

FIG. 5 shows a process for matching a list of well-identified names against weakly or non-uniquely identified names. Initially, where a strong link is available, easy matches are found by matching 140 those SEC records for which an SSN is available, by comparing, in the case of weakly identified SEC officers and directors, SEC names and SSNs to CPS names and SSNs. The accuracy of an SSN match 140 is improved by the initial cleansing 54 of the CPS, dataset 56 and by cleansing of the SEC dataset 57.

For those SEC records where a match 140 by SSN or some other identification key is not possible, a name and age match 142 is performed. Generally, SEC records have a date that indicates when the record was created or a point in time when the data of the record was obtained, for example by the filing of an SEC Form 144. When an SEC name matches a CPS name, it is possible to determine whether the two names correspond to the same individual by comparing the date-adjusted SEC age (or an equivalent d.o.b) with the CPS d.o.b/age. A match 142 will indicate that the SEC record and CPS record with the same name are reasonably likely to correspond to the same individual.

For those SEC records of SEC dataset 57 where an SSN and age/date are not available, a match 144 based on name and address(es) is used. Where the SEC address and the CPS address for the same name match, then a match 144 is assumed. Furthermore, using address records from the PRN dataset 50, it is also possible to determine a match where the SEC address and the CPS address are not the same. In this case, a set of historical addresses from the PRN dataset 50, preferably going back 15 years, are linked to the well-identified CPS subject. The historical address(es) preferably include all known work or residential addresses of the subject. If the SEC address matches one of the historical addresses, then a match 144 is assumed.

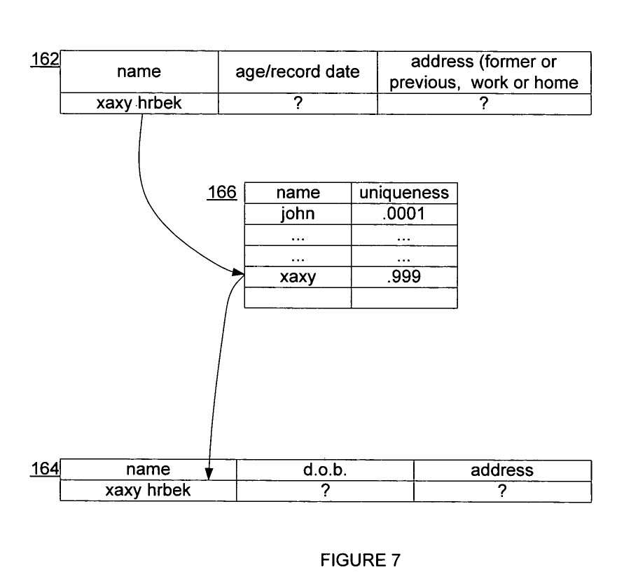

In cases where only an SEC name is available, name-uniqueness matching 146 is used to determine a reasonable match. See the discussion of FIG. 7.

Finally, for the application of determining whether a subject is an officer or director of a publicly traded company, the obligation of a firm to identify close relatives of an officer or director can be met by using cohabitation as an indicator of familial or relational immediacy. The PRN address information is used to find 148 people who have co resided with an officer or director of a publicly traded company. The algorithm is similar to that discussed in step 144. Preferably, a determination of whether a person is an immediate family member is based on whether that person shared an address with the officer or director for 5 years (or some other period), or for two or more consecutive addresses. For example, if CEO Chris Smith resided at address1 for 5 years, and Pat Smith also resided at address1 for the same period of time, then Pat Smith is assumed to be closely related to Chris Smith. Or, if the Chris Smith resided at address1 and then address2, and if Path Smith also resided at address1 and then address2, then Pat Smith would also be assumed to be closely related Chris Smith. Potential close relations can be derived from a number of sources, including the PRN dataset 50, the CPS dataset 56, and so on. Preferably, possible close relations are extracted from free-form text fields in the CPS dataset 56 records, which may contain ad-hoc information related to an account holder, such as trust or inheritance information.

Although steps 142, 144, and 146 are shown in sequence in FIG. 5, these matching algorithms may be performed in different orders, in different, combinations, and so on. For example, steps 142, 144, and 146 may all be used when all of the non-SSN SEC information is available (e.g. name, age, and, address). The results may be used to return all possible name iterations, ranked in order of likelihood of identity. For example, when an SEC name's age and address are both available, and both match a particular CPS record, the likelihood of true identity between them will be higher than if the address was not available and a match was determined based only on name and age.

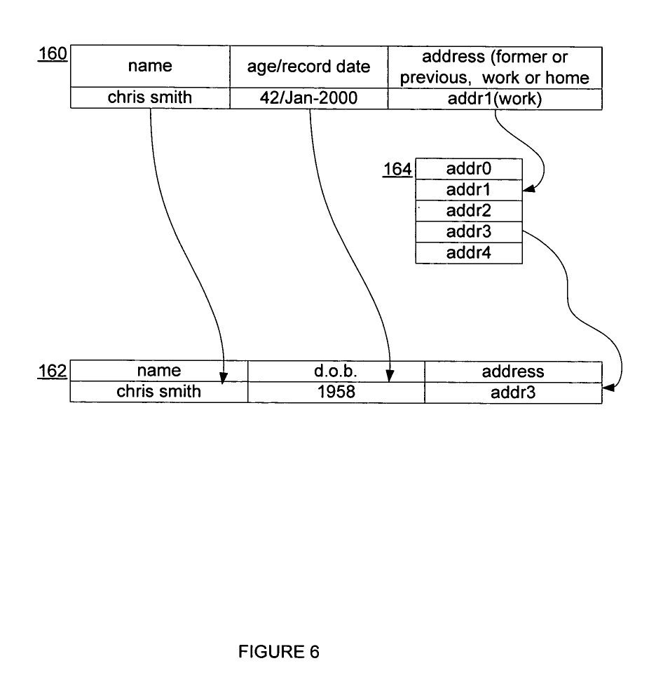

FIG. 6 shows an example of address matching technique. In the address matching 144 discussed with reference to FIG. 5, where an SEC record 160 matches the name of a CPS record 162, or optionally where an age/d.o.b. match also occurs, a set of addresses 164 from the PRN dataset 50 is used to match the addresses of the two records. The set of addresses 164 preferably includes all work or residential addresses from the previous 15 years that are associated with the Chris Smith of CPS record 162. Thus, whether the address of the SEC record 160 is or was a work or residential address, an address match can still be determined. In sum, identity can be established between the two Chris Smith records 160, 162 by determining that a same “Chris Smith” used two addresses (e.g. addr1 and addr3) held by one known person, each associated with one of the Chris Smith records 160, 162.

FIG. 7 shows an example of name-uniqueness matching 146. The name-uniqueness matching may be performed individually to confirm a name match, or it may be performed in combination with the matching of other available pieces of information. In the example shown in FIG. 7, a surname “xaxy” is matched to a pre-existing list of name uniqueness rankings. In this example, the uncommon name of “xaxy” has a ranking of 0.999, which is used to determine that the SEC record 160 and the CPS record 162 matches with reasonable certainty. The uniqueness of a last name may also be taken into account, or a combined surname and last name uniqueness rating may be used.

In test cases processed according to the above, success rates of approximately 50% have been achieved. Adjusting some parameters such as the 15 year mark for addresses, the year residency parameter, changing the cut-off point for uniqueness of a name, and so on, may all be altered according to a desired balance between accuracy and inclusiveness.

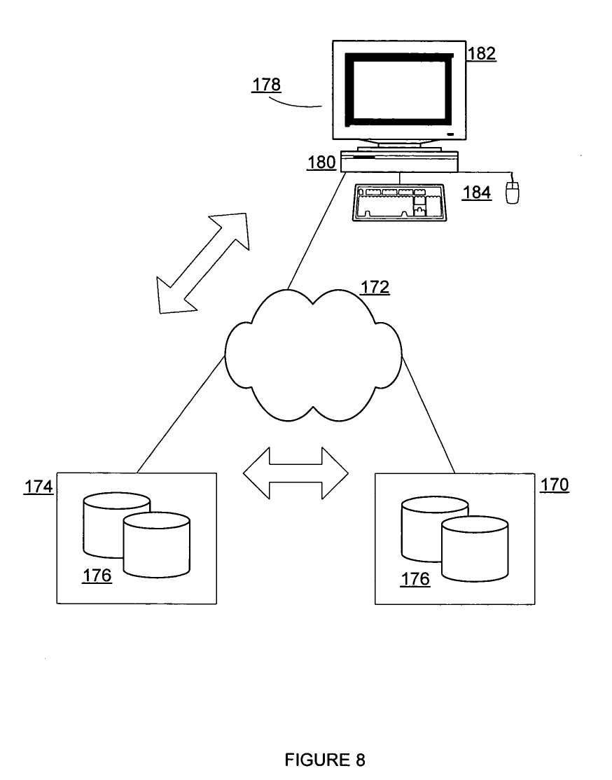

FIG. 8 shows one of many possible hardware configurations that may be used to implement embodiments of the present invention. Generally, information such public records mentioned above may be transmitted from servers 170 of a data provider such as Thomson Analytics, over a network 172, to servers 174 implementing aspects of the invention mentioned above. The servers 172 and 174 may include one or more preferably commercial databases 176. The information needed by servers 172 may be provided by servers 174 either wholesale where it is then searched at servers 172, or it may be provided be maintained and searched at servers 172 as needed. Searches using aspects of the present invention may be conducted by a user using a workstation 178, which may include a processing unit 180, a display 182, and input devices 184. The workstation 178 may function as a client accessing the servers 174 through the network 172, for example using HTTP or other IP-based protocols. Not shown are other computers, for example SEC servers or servers of trading firms that may provide the SEC and account holder information discussed above. Batch exchanges of data, and updates to the trading firms over the network 172 (based on search results) may also be conducted.

Other Applications

The methods discussed above are not limited to the application of identifying officers and directors of publicly traded companies. The method of linking weakly identified names with strongly identified names based on common address, age/d.o.b, name uniqueness, etc. can be extended to other applications. For example, aspects of the invention may be used to satisfy duties imposed by the Patriot Act and the Know Your Customer Act.

Aspects of the present invention have been described with respect to a system and method that determines whether a non-uniquely identified name substantially corresponds to a uniquely identified person. A source dataset of uniquely identified persons is accessed, where the source dataset has records including, for each uniquely identified person, a source name, a source unique identifier, a source date of birth, and a source address. A target dataset of non-uniquely identified persons is also accessed, where the target dataset has records that include, for each non-uniquely identified person, a target name, and either (1) a target age and a target age-date indicating an exact or approximate date of the target age, or (2) a target address. For a particular source person in the source dataset, whether the particular source person corresponds to a particular target person in the target dataset is determined automatically in accordance with the accessing.

In a preferred embodiment the results of the inquiry are automatically compared against the profile of the client, which is updated and sent back to a requestor in an encrypted format. A typical embodiment will be capable of performing 20,000 or more searches per day, and will return the clean data sets to a customer. It is also preferable to automatically validate certain fields of data as contained within the customer profile, such as the customer's True Name, True DOB, True Age, True Social Security account number, True current home address, True home phone number, True name of current spouse, and True maiden name or second name of spouse. Any anomalies are preferably highlighted in a NOTES section of the customer's profile.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

Appendix

### Role Code Summary

The role codes in the table below should be prioritized in terms of COLE CODE 1—ROLE CODE4 according to the following hierarchy:

ROLE CODE1 (highest): CB, CEO, CO, GC, P
ROLE CODE2: AC, AF, CC, CFO, CI, CT, D, DO, EC, FC, GP, H, M,
MC, MD, O, OB, OD, OP, OS, OT, OX, S, SC, TR, VC
ROLE CODE3: AV, C, EVP, OE, GM, LP, SVP, T, VP
ROLE CODE4: AI, B, BC, BT, CP, DS, F, FO, IA, R, SH, UT, VT, X

| Classification | Code | Description |
|---|---|---|
| Directors | CB | Chairman of the Board |
| | D | Director |
| | DO | Director and Beneficial Owner of more than |
| | | 10% of a Class of Security |
| | H | Officer, Director and Beneficial Owner |
| | OD | Officer and Director |
| | VC | Vice Chairman |
| Committees | AC | Member of the Advisory Committee |
| | CC | Member of the Compensation Committee |
| | EC | Member of the Executive Committee |
| | FC | Member of the Finance Committee |
| | MC | Member of Committee or Advisory Board |
| | SC | Member of the Science/Technology |
| | | Committee |
| Officers | AV | Assistant Vice President |
| | CEO | Chief Executive Officer |
| | CFO | Chief Financial Officer |
| | CI | Chief Investment Officer |
| | CO | Chief Operating Officer |
| | CT | Chief Technology Officer |
| | EVP | Executive Vice President |
| | O | Officer |
| | OB | Officer and Beneficial Owner of more than |
| | | 10% of a Class of Security |
| | OP | Officer of Parent Company |
| | OS | Officer of Subsidiary Company |
| | OT | Officer and Treasurer |
| | OX | Divisional Officer |
| | P | President |
| | S | Secretary |
| | SVP | Senior Vice President |
| | VP | Vice President |
| Affiliates | AF | Affiliated Person |
| | AI | Affiliate of Investment Advisor |
| | GC | General Counsel |
| | IA | Investment Advisor |
| Beneficial Owners | B | Beneficial Owner of more than |
| | | 10% of a Class of Security |
| | BC | Beneficial Owner as Custodian |
| | BT | Beneficial Owner as Trustee |
| Other | C | Controller |
| | CP | Controlling Person |
| | DS | Indirect Shareholder |
| | F | Founder |
| | FO | Former |
| | GM | General Manager |
| | GP | General Partner |
| | LP | Limited Partner |
| | M | Managing Partner |
| | MD | Managing Director |
| | OE | Other Executive |
| | R | Retired |
| | SH | Shareholder |
| | T | Trustee |
| | TR | Treasurer |
| | UT | Unknown |
| | VT | Voting Trustee |
| | X | Deceased |

Security Title Summary

| Code | Description | Code | Description |
|---|---|---|---|
| ADR | American Depository Receipts | ORD A | Ordinary Shares, Series A |
| BEN | Beneficial Shares | ORD B | Ordinary Shares, Series B |
| BOND | Bond | ORD C | Ordinary Shares, Series C |
| CALL | Call Option | ORD D | Ordinary Shares, Series D |
| CLLR | Collar or Similar Security Title | ORD E | Ordinary Shares, Series E |
| COM | Common Stock | ORD F | Ordinary Shares, Series F |
| COM A | Common Stock, Class A | ORD G | Ordinary Shares, Series G |
| COM B | Common Stock, Class B | ORD H | Ordinary Shares, Series H |
| COM C | Common Stock, Class C | ORD I | Ordinary Shares, Series I |
| COM D | Common Stock, Class D | ORD J | Ordinary Shares, Series J |
| COM E | Common Stock, Class E | ORD K | Ordinary Shares, Series K |
| COM F | Common Stock, Class F | ORD L | Ordinary Shares, Series L |
| COM G | Common Stock, Class G | ORD M | Ordinary Shares, Series M |
| COM H | Common Stock, Class H | ORD N | Ordinary Shares, Series N |
| COM I | Common Stock, Class I | ORD O | Ordinary Shares, Series O |
| COM J | Common Stock, Class J | ORD P | Ordinary Shares, Series P |
| COM K | Common Stock, Class K | ORD Q | Ordinary Shares, Series Q |
| COM L | Common Stock, Class L | ORD R | Ordinary Shares, Series R |
| COM M | Common Stock, Class M | ORD S | Ordinary Shares, Series S |
| COM N | Common Stock, Class N | ORD T | Ordinary Shares, Series T |
| COM O | Common Stock, Class O | ORD U | Ordinary Shares, Series U |
| COM P | Common Stock, Class P | ORD V | Ordinary Shares, Series V |
| COM Q | Common Stock, Class Q | ORD W | Ordinary Shares, Series W |
| COM R | Common Stock, Class R | ORD X | Ordinary Shares, Series X |
| COM S | Common Stock, Class S | ORD Y | Ordinary Shares, Series Y |
| COM T | Common Stock, Class T | ORD Z | Ordinary Shares, Series Z |
| COM U | Common Stock, Class U | PAIR | Paired Shares |
| COM V | Common Stock, Class V | PART | Partnership or Partnership |
| | | | Interest |
| COM W | Common Stock, Class W | PERF | Performance Shares |
| COM X | Common Stock, Class X | PFD | Preferred Stock |
| COM Y | Common Stock, Class Y | PFD A | Preferred Stock Series A |
| COM Z | Common Stock, Class Z | PFD B | Preferred Stock Series B |
| COMNV | Common Stock, Non-Voting | PFD C | Preferred Stock Series C |
| CTF | Certificate | PFD D | Preferred Stock Series D |
| CVD | Convertible Debentures | PFD E | Preferred Stock Series E |
| CVP | Convertible Preferred | PFD F | Preferred Stock Series F |
| CVS | Convertible Securities | PFD G | Preferred Stock Series G |
| DEFR | Deferred Security, Award, or Compensation | PFD H | Preferred Stock Series H |
| DIREO | Non-Employee Director Stock Option | PFD I | Preferred Stock Series I |
| DIRO | Director's Stock Options | PFD J | Preferred Stock Series J |
| EMPO | Employee Stock Option | PFD K | Preferred Stock Series K |
| EQSWP | Equity Swap | PFD L | Preferred Stock Series L |
| EQUIV | Common Stock Equivalents | PFD M | Preferred Stock Series M |
| EXFND | Exchange Fund or Similar Security Title | PFD N | Preferred Stock Series N |
| FWD | Forward Sale | PFD O | Preferred Stock Series O |
| ISO | Incentive Stock Option | PFD P | Preferred Stock Series P |
| NONQ | Non-Qualified Stock Option | PFD Q | Preferred Stock Series Q |
| NTS | Notes (Convertible or Otherwise) | PFD R | Preferred Stock Series R |
| OPTNS | Options | PFD S | Preferred Stock Series S |
| ORD | Ordinary Shares | PFD T | Preferred Stock Series T |
| PFD U | Preferred Stock Series U | | |
| PFD V | Preferred Stock Series V | | |
| PFD W | Preferred Stock Series W | | |
| PFD X | Preferred Stock Series X | | |
| PFD Y | Preferred Stock Series Y | | |
| PFD Z | Preferred Stock Series Z | | |
| PFDDU | Preferred Depositary Units | | |
| PHNTM | Phantom Stock | | |
| PUT | Put Option | | |
| RCPT | Receipt | | |
| RGHTS | Rights | | |
| RSTK | Restricted Stock | | |
| SAR | Stock Appreciation Right | | |
| SBI | Shares of Beneficial Interest | | |
| SH | Shares | | |
| UKN | Unknown | | |
| UTS | Units | | |
| UTS A | Units, Series A | | |
| UTS B | Units, Series B | | |
| UTS C | Units, Series C | | |
| UTS D | Units, Series D | | |
| UTS E | Units, Series E | | |
| UTS F | Units, Series F | | |
| UTS G | Units, Series G | | |
| UTS H | Units, Series H | | |
| UTS I | Units, Series I | | |
| UTS J | Units, Series J | | |
| UTS K | Units, Series K | | |
| UTS L | Units, Series L | | |
| UTS M | Units, Series M | | |
| UTS N | Units, Series N | | |
| UTS O | Units, Series O | | |
| UTS P | Units, Series P | | |
| UTS Q | Units, Series Q | | |
| UTS R | Units, Series R | | |
| UTS S | Units, Series S | | |
| UTS T | Units, Series T | | |
| UTS U | Units, Series U | | |
| UTS V | Units, Series V | | |
| UTS W | Units, Series W | | |
| UTS X | Units, Series X | | |
| UTS Y | Units, Series Y | | |
| UTS Z | Units, Series Z | | |
| UTSLP | Units of Limited Partnership | | |
| WT | Warrants | | |

### Transaction Code and Acquisition/Disposition Indicator Definitions

Transaction Code Summary General Transaction Codes

P Open market or private purchase of non-derivative or derivative security
S Open market or private sale of non-derivative or derivative security
V Transaction voluntarily reported earlier than required Note this code does not appear on Form 5
   Employee Benefit Plan Transaction Codes
A Grant or award transaction pursuant to Rule 16b-3(c)
M Exercise of in-the-money or at-the-money derivative security acquired pursuant to Rule 16b-3 plans
B Participant-directed transaction in ongoing acquisition plan pursuant to Rule 16b-3(d)(2) (except for intra-plan transfers specified in Code I) (**no longer in use as of 8-96)
N Participant-directed transactions pursuant to Rule 16b-3(d)(1) (**no longer in use as of 8-96)
F Payment of option exercise price or tax liability by delivering or withholding securities incident to exercise of a derivative security issued in accordance with Rule 16b-3
I Discretionary transaction in accordance with Rule 16b-3(F) resulting in an acquisition or disposition of issuer securities
T Acquisition or disposition transaction under an employee benefit plan other than pursuant to Rule 16b-3 (**no longer in use as of 8-96)
   Derivative Securities Codes
E Expiration of short derivative position
H Expiration (or cancellation) of long derivative position
C Conversion of derivative security
O Exercise of out-of-the-money derivative security
X Exercise of in-the-money or at-the-money derivative security

Other Section 16(b) Exempt Transactions and Small Acquisition Codes (except for employee benefit plan codes above)
G Bona fide gift
R Acquisition pursuant to reinvestment of dividends or interest (DRIPS) (**no longer in use as of 8-96)
W Acquisition or disposition by will or laws of descent or distribution
L Small acquisition under Rule 16a-6
Z Deposit into or withdrawal from voting trust
   Other Transaction Codes
J Other acquisition or disposition (describe transaction)
Q Transfer pursuant to a qualified domestic relations order (**no longer in use as of 8-96)
U Disposition pursuant to a tender of shares in a change of control transaction
   New Transaction Codes (as of 8-96)
D Disposition to the issuer of issuer equity securities pursuant to Rule 16b-3(e)
K Transaction in equity swap or instrument with similar characteristics
   Value Added Transaction Codes
6 Transaction code reported as an M or C and as a disposition of nonderivative securities. This combination is invalid and data cleansing cannot determine with any confidence which of the elements of the transaction was reported incorrectly.
7 Disposition of exercised securities. Disposition may be an open market sale or return of securities to the issuer, the exact nature cannot be determined.
8 A holdings record (without an associated transaction record) was reported on Form 4 or 5.
9 Transaction code cannot be determined from the reported transaction code (i.e., there are two or more valid characters reported, or at least one invalid character, reported in the transaction code field).
   Unidentifiable Historic Transaction Codes (1986-1995)
3 From Form 3
4 From Form 4
   Acquisition/Disposition Code Summary
A Acquisition of a derivative or nonderivative security
D Disposition of a derivative or nonderivative security

9 Acquisition/disposition code missing or invalid and could not be determined from the transaction code. (Note that both A and D are valid acquisition/disposition codes for certain transaction codes.)

Cleanse Indicator Summary

| Cleanse | | |
|---|---|---|
| indicator | Meaning | Assigned when: |
| R | Data verified | Record passed all data cleansing |
| | through cleansing | checks for reasonableness. |
| | process | |
| H | Cleansed, with a | All data cleansing updates were made |
| | very high level of | with high confidence. |
| | confidence | |
| L | Cleansed | One or more data cleansing actions |
| | | were undertaken but secondary |
| | | sources were unavailable for complete |
| | | verification. |
| I | Improved | Some data elements were improved |
| | | (inserted or replaced) in order to make |
| | | the data usable. In some cases, |
| | | records with a cleanse indicator of ‘I’ |
| | | may contain data that could not be |
| | | verified or were determined to be |
| | | outside of a reasonable range. |
| C | Corresponding | A record added to nonderivative table |
| | record added | or derivative table in order to |
| | | correspond with a record on the |
| | | opposing table. |
| W | Mis-reported | Identifies an improperly reported |
| | holdings record | holdings record on the derivative |
| | | table. This occurs when the insider |
| | | reports a holdings value in the number |
| | | of derivatives or number of underlying |
| | | shares field (and no value was |
| | | reported for resulting derivatives held). |
| Y | Informational | An as-reported holdings value |
| | | identified by data cleansing. |
| S | Security not | Security does not meet our collection |
| | maintained, no | requirements |
| | cleansing attempted | |
| A | Attempted | Numerous data elements were |
| | cleansing, data | missing or invalid; reasonable |
| | appears | assumptions could not be made. |
| | unreasonable/ | |
| | inconsistent | |

Sector Classifications

| Sector | Sector Name |
|---|---|
| 00 | Not Classified |
| 01 | Finance |
| 02 | Healthcare |
| 03 | Consumer Non Durable |
| 04 | Consumer Services |
| 05 | Consumer Durables |
| 06 | Energy |
| 07 | Transportation |
| 08 | Technology |
| 09 | Basic Industries |
| 10 | Capital Goods |
| 11 | Public Utilities |
| 99 | Miscellaneous |
| XX | Not Classified |

Industry Classifications

| | | Industry |
|---|---|---|
| Sector | Industry | Name |
| 01 | 01 | Finance & Loan |
| 01 | 02 | Financial Services |
| 01 | 03 | Savings And Loans |
| 01 | 04 | Banking |
| 01 | 05 | Insurance |
| 01 | 06 | Investments |
| 01 | 07 | Leasing |
| 01 | 09 | Undesignated Finance |
| 01 | 10 | Multi-Industry Finance |
| 01 | 30 | Eafe Banking |
| 01 | 35 | Eafe Financial Services |
| 01 | 48 | Eafe Insurance |
| 01 | 64 | Eafe Real Estate |
| 02 | 01 | Drugs |
| 02 | 02 | Hospital Supplies |
| 02 | 03 | Hospitals |
| 02 | 04 | Biotechnology |
| 02 | 05 | Medical Supplies |
| 02 | 06 | Services To Medical Prof |
| 02 | 07 | Home Health Care |
| 02 | 09 | Undesignated Health |
| 02 | 45 | Eafe Health Care |
| 02 | 99 | Eafe Hea Multi-Industry |
| 03 | 01 | Clothing |
| 03 | 03 | Cosmetics |
| 03 | 04 | Food Processors |
| 03 | 05 | Beverages |
| 03 | 06 | Home Products |
| 03 | 07 | Leisure Time |
| 03 | 09 | Tobacco |
| 03 | 12 | Undesignated Conr Non Du |
| 03 | 40 | Eafe Beverages & Tobacco |
| 03 | 50 | Eafe Food & Household |
| 03 | 51 | Eafe Recreation |
| 04 | 01 | Communications |
| 04 | 02 | Leisure |
| 04 | 03 | Retailing - Foods |
| 04 | 04 | Retailing - Goods |
| 04 | 05 | Industrial Services |
| 04 | 07 | Undesignated Conr Svc |
| 04 | 33 | Eafe Broadcast & Pub |
| 04 | 41 | Eafe Bus & Pub Service |
| 04 | 46 | Eafe Leisure & Tourism |
| 04 | 51 | Eafe Merchandising |
| 04 | 98 | Eafe Intl Trading |
| 05 | 01 | Automotive Mfg |
| 05 | 02 | Auto Part Mfg |
| 05 | 03 | Home Building |
| 05 | 04 | Home Furnishings |
| 05 | 05 | Leisure Products |
| 05 | 06 | Recreational Vehicles |
| 05 | 07 | Rubber |
| 05 | 08 | Tools And Hardware |
| 05 | 13 | Undesignated Conr Dur |
| 05 | 31 | Eafe Appliances |
| 05 | 36 | Eafe Automobiles |
| 06 | 01 | Oil |
| 06 | 02 | Coal |
| 06 | 05 | Undesignated Energy |
| 06 | 07 | Gas |
| 06 | 08 | Alternative Energy |
| 06 | 42 | Eafe Energy Sources |
| 06 | 44 | Eafe Energy Equipment |
| 07 | 01 | Airlines |
| 07 | 02 | Railroads |
| 07 | 03 | Trucking |
| 07 | 05 | Maritime |
| 07 | 06 | Multi-Ind Transport |
| 07 | 62 | Undesignated Transport |
| 07 | 99 | Eafe Tra Multi-Industry |
| 08 | 01 | Computer Mfrs |
| 08 | 03 | Electronics |
| 08 | 04 | Software & Edp Services |
| 08 | 07 | Other Computers |
| 08 | 08 | Semiconductors/Component |
| 08 | 09 | Photo-Optical Equipment |
| 08 | 10 | Electronic Syst/Devices |
| 08 | 11 | Office/Comm Equip |
| 08 | 12 | Undesignated Technology |
| 08 | 54 | Eafe Data Processing |
| 08 | 56 | Eafe Electronic Corp |
| 08 | 99 | Eafe Tec-Multi Industry |
| 09 | 01 | Building & Related |
| 09 | 02 | Chemicals |
| 09 | 03 | Containers |
| 09 | 04 | Metal Fabricators & Dist |
| 09 | 06 | Forest Products |
| 09 | 08 | Steel |
| 09 | 09 | Textiles |
| 09 | 10 | Nonferrous Base Metals |
| 09 | 11 | Precious Metals |
| 09 | 12 | Multi-Ind Basic |
| 09 | 57 | Eafe Chemicals |
| 09 | 59 | Eafe Metals NonFer |
| 09 | 60 | Eafe Metals Steel |
| 09 | 73 | Eafe Gold Mining |
| 09 | 99 | Eafe Bas Multi Industry |
| 10 | 01 | Defense |
| 10 | 03 | Electrical |
| 10 | 04 | Machinery |
| 10 | 05 | Shipbuilding |
| 10 | 06 | Truck Mfg |
| 10 | 07 | Building Materials |
| 10 | 08 | Office Products |
| 10 | 10 | Multi-Ind Cap Good |
| 10 | 11 | Undesignated Capital |
| 10 | 74 | Eafe Building Materials |
| 10 | 77 | Eafe Electrical & Elect |
| 10 | 78 | Eafe Industrial Comp |
| 10 | 79 | Eafe Machinery & Eng |
| 11 | 01 | Electrical Utilities |
| 11 | 02 | Gas Utilities |
| 11 | 03 | Telephone Utilities |
| 11 | 05 | Water Utilities |
| 11 | 80 | Eafe Utilities |
| 11 | 81 | Eafe Telecommunications |
| 99 | 00 | Unclassified |

Field Definitions
Acquisition/Disposition Flag

An acquisition/disposition indicator should accompany each transaction code reported by the insider. If this field is not provided or is inconsistent with the reported transaction code, the data cleansing process will correct the acquisition/disposition code. Valid codes are A=Acquired; D=Disposed. The as-reported code, including null (or “blanks”) codes, is always available in the Acquisition/Disposition (AR) field.

Acquisition/Disposition Flag (AR)

This field provides the as-reported acquisition/disposition indicator. See Acquisition/Disposition Flag above.

Address 1

This field lists the reported Street Address.

Address 2

This field includes any Suite or Building Number. P.O. Box may also be included, if provided in addition to Street Address.

Amendment Indicator

This field indicates whether a record represents an amendment made to an earlier filing. If the filing represents an amendment to an earlier filing, an “A” will appear in this field. Otherwise, the field will be left blank.

Average 3 Month Return Buys

This field contains the average 3-month performance returns following a given insider's purchase decisions. When calculating returns, we aggregate similar transactions to a seven-day period.

Average 3 Month Return Sells

This field contains the average 3-month performance returns following a given insider's sell decisions. When calculating returns, we aggregate similar transactions to a seven-day period.

Average 6 Month Return Buys

This field contains the average 6-month performance returns following a given insider's purchase decisions. When calculating returns, we aggregate similar transactions to a seven-day period.

Average 6 Month Return Sells

This field contains the average 6-month performance returns following a given insider's sell decisions. When calculating returns, we aggregate similar transactions to a seven-day period.

Broker Name

Insiders must provide the name of the executing broker on Form 144; the Broker Name field contains the name of the executing broker.

City

This field displays the insider's reported city of residence.

Cleanse Indicator

Thomson's proprietary data cleansing process verifies the accuracy and reasonableness of insider reported figures by reference to external sources. Data (e.g., transaction prices, acquisition/disposition indicators, etc.) that appear erroneous or unreasonable are corrected by substituting information from alternative sources. The Cleanse Indicator indicates Thomson's level of confidence concerning the accuracy of a particular record contained in the database. There are nine cleanse indicators:

| Cleanse | |
|---|---|
| Indicator | Meaning |
| R | Data verified through the cleansing process. |
| H | Cleansed with a very high level of confidence. |
| L | One or more data cleansing actions were |
| | undertaken but secondary sources were |
| | unavailable for complete verification. |
| I | Some data elements were improved (inserted or |
| | replaced) in order to make the data usable. In |
| | some cases, records with a cleanse indicator of ‘I’ |
| | may contain data that could not be verified or were |
| | determined to be outside of a reasonable range. |
| C | A record added to nonderivative table or derivative |
| | table in order to correspond with a record on the |
| | opposing table. |
| W | Indicates an improperly reported holdings record |
| | on the derivative table. This occurs when the |
| | insider reports a holdings value in the number of |
| | derivatives or number of underlying shares field |
| | (and no value was reported for resulting derivatives |
| | held). |
| Y | An as-reported holdings value identified by data |
| | cleansing. |
| S | No cleansing attempted; security does not meet |
| | our collection requirements |
| A | Numerous data elements were missing or invalid; |
| | reasonable assumptions could not be made. |

Company Name

This field refers to the name of the company (or issuer) at the time of the filing.

Company Number

Internal company number.

Conversion/Exercise Price

The value in this field contains the per unit cost to the insider to convert the derivative security into a nonderivative security (e.g., the exercise or strike price).

Country Code

This field displays the insider's reported country of residence.

Create Date

This field represents the creation date of the record.

Cusip Issuer/Issue

These fields display the first eight digits of the CUSIP number. Full refreshes contain the CUSIP of the security at the time of the refresh. Ongoing updates contain the CUSIP at the time of the filing. Inactive securities will be populated with the last available CUSIP information for that security. The CUSIP number is a unique identifier for issuers and issues of securities and financial instruments. The CUSIP Service Bureau maintains CUSIP numbers.

Cusip Check

The CUSIP Check digit provides a means of mathematically verifying the accuracy of the CUSIP issuer and issue numbers.

DCN

The DCN is a unique number assigned to each document that allows us to track information back to the original source.

Derivative Type

This field contains an abbreviated description of the derivative type exchanged in the transaction.

Exercise Date

This is the earliest date the derivative may be exercised. If the insider provides the exercisable, the data cleansing process performs a validity check. If the as-reported exercise date is in the future, but the reported transaction is an option exercise, the transaction date is substituted for the exercisable date. If the insider fails to provide the exercisable date, Exercise Date field is not filled.

Expiration Date

This field contains the expiration date for the derivative position. If the as-reported expiration date precedes the transaction date, the transaction date is substituted for the expiration date. If the insider fails to provide the expiration date, the Expiration Date field is not filled.

File Date

This field represents the date the file was created.

Form Type

This field denotes the type of filing the insider filed. Possible insider form types are:

Form 3—Initial statement that identifies holdings of registrant's securities owned by directors, officers and 10% shareholders. A Form 3 must be filed within 10 days after the event.

Form 4—Amendment to Form 3 reporting a sale or acquisition of registrant's securities. Prior to Aug. 29, 2002, Form 4s had to be filed by the tenth day of the calendar month following their transaction. The Sarbanes-Oxley Act of 2002 amended Section 16(a), now requires insiders to report such a change in ownership before the end of the second business day following the execution of their transaction.

Form 5—Annual section 16 filing filed 45 days after the company's fiscal year end.

Form 144—A form filed as notice of the proposed sale of restricted securities, or securities held by an affiliate of the issuer in reliance on Rule 144 when the amount to be sold during any three-month period exceeds 500 shares or has an aggregate sales price in excess of $10,000.

Industry Code

This field refers to the Industry Code as it relates to the Industry. (See above for the complete list of industries.)

Last Maintenance Date

The last day that a record was touched.

Market Value of Transaction

This field contains the total market value of the proposed sale. A common mistake made by insiders is to report the market capitalization of the company, rather than the market value of the proposed transaction. The data cleansing process corrects this type of error by comparing the derived price per share with an external pricing source. If this is corrected (or filled in the case of missing data) the as-reported value is always available in the Market Value of Transaction (AR) field.

Market Value of Transaction (AR)

This field provides the as-reported Market Value. See Market Value of Transaction above.

Nature of the Acquisition

This field contains a description of how the shares were acquired by the insider. Examples include shares acquired through the exercise of stock options or shares acquired by the founder during an initial public offering.

Number of Buy Decisions

The number of times an insider has historically purchased shares at this company. Please note: Decisions span a seven-day period.

Number of Derivatives

This field denotes the number of derivatives exchanged in the transaction.

Number of Sell Decisions

The number of times an insider has historically sold shares at this company. Please note: Decisions span a seven-day period.

Number of Shares

This field denotes the number of shares exchanged in the transaction.

Option Sell Indicator

This field identifies a sale that is related to the exercise of options. The indicator works at the document level. This field can be ‘A’ for all, ‘P’ for partial, ‘N’ for none or empty.

Owner Full Name

This field refers to the filing insider's complete name in the order of last name, first name, middle name and suffix.

Ownership Type

The values in this field denote the form of the insider's beneficial ownership—i.e., direct (‘D’) or indirect (‘I’). Direct beneficial ownership applies to equity securities held in the insider's name, or in the name of a broker, bank or nominee on behalf of the insider. Indirect ownership occurs when an insider's position creates a reportable pecuniary interest [e.g., securities held in a trust when the insider is a beneficiary (investment partnership) and/or securities held by members of the insider's immediate family sharing the same household]. An insider may transact in both their direct and indirect positions, denoted by an ownership type of ‘D/I’.

Person ID

Person ID is our internally assigned unique identifier that allows for consistent and accurate identification of individual insiders. Since Social Security Number is no longer a required field, a system for person identification is critical. The Person ID ensures that an insider is not represented multiple times (e.g., John Ronald Smith, John R. Smith, etc.) within his or her own company. This unique identifier also allows the user to accurately track an individual's transactions over time.

Phone Number

This field displays the insider's phone number, if provided, on the Form 144.

Postal Code

This field displays the insider's reported zip code or foreign postal code.

Proposed Number of Shares

This is the number of shares that the insider intends to sell within 90 days, remembering that he/she may elect to sell only a portion of that total. To ensure the highest level of accuracy this number is subjected to a check to insure the proposed number of shares falls within a reasonable range.

If the proposed number of shares to be sold is not provided by the insider but the market value of the proposed transaction is, we will derive a proposed number of shares to be sold. This number will then be subjected to the reasonableness test. The as-reported number can be found in the field Proposed Number of Shares (AR).

Proposed Number of Shares (AR)

This field provides the as-reported proposed number of shares to be sold. See Proposed Number of Shares above.

Proposed Sale Date

This field represents the expected sale date. A Form 144 is effective for 90 days from the time it is filed. The date provided is the insider's best estimate of the future sale date. As a practical matter, most insiders file a Form 144 just prior to (or on the same day of) a sale. Since the Form 144 must be filed prior to a sale of restricted stock, it serves as an early warning notification of upcoming sales. We provide both the cleansed and as-reported fields.

Proposed Sale Date (AR)

This field provides the as-reported proposed sale date. See Proposed Sale Date above.

Resulting Shares/Derivatives Held

This field represents the insider's ownership position (direct and indirect) in the issuer's securities.

Role Codes 01-04

These fields refer to the insider's roles or positions within the company, as reported on the filing. See above for the complete list of role codes.

Sector Code

This field refers to the Sector Code as it relates to the Sector. (See above for the complete list of sectors.)

Security ID

Security ID is our internally assigned unique identifier that allows for consistent and accurate identification of securities. It allows the user to link company data, regardless of changes in company name or ticker.

SEC Receipt Date

This field provides the date that the filing was received by the Securities and Exchange Commission (e.g., the “SEC Stamp Date”).

Sequence Number

This field serves as a row count within a document. When used in conjunction with DCN, the user can uniquely identify every record.

Signature Date

This field provides the date that the filing was signed by the insider or by a person authorized to sign on behalf of the insider.

State

This field displays the two-character abbreviation for the insider's reported state of residence. This field applies only for domestic addresses.

Ticker Symbol

This field represents the ticker symbol for the company at which the insider transacted at the time of the transaction. If the company is inactive at the time that the data is run, the ticker field will be blank.

Transaction Code

Transaction codes provided by the insider describe the nature of the underlying transaction. Examples of valid transaction codes include, “P” for open market purchase, “S” for open market sale, “X” for a conversion (e.g., exercise) of a derivative security into a nonderivative security. The list of allowable codes is codified by the Securities and Exchange Commission (see above).

Data cleansing plays an especially important role in verifying as-reported transaction codes. Insiders frequently report incorrect or erroneous codes, particularly in cases involving more complex transactions, such as those related to options, rights, convertible securities, and phantom stock.

When a code reported by an insider is clearly incorrect, data cleansing assigns a corrected (cleansed) code. (Note: If the transaction code is not provided by the insider, it will not be filled in unless there is clear evidence of the appropriate code). If a transaction code is corrected by the data cleansing process, the as-reported transaction code is still available in the Transaction Code (AR) field.

Transaction Code (AR)

This field provides the as-reported transaction code. See Transaction Code above.

Transaction Date

Values in the Transaction Date field represent either a transaction date or holdings report date. The Transaction Date field is evaluated for accuracy by reference to records of valid market dates. If Transaction Date is modified by the data cleansing process, the as-reported transaction date is still available in the Transaction Date (AR) field.

Transaction Date (AR)

The transaction date as reported by the insider. See Transaction Date above.

Transaction Price

This field contains the transaction price. Thomson verifies all reported transaction prices to ensure the accuracy of the information. If the reported price falls outside a reasonable range (by reference to our external pricing source) the data cleansing process substitutes the security's closing price for the reported transaction date. The as-reported transaction price is always available in the Transaction Price (AR) field.

Transaction Price (AR)

This field provides the as-reported transaction price. See Transaction Price above.

Underlying Market Price

This field contains the per share or unit value of the derivative security

Underlying Shares

This field (when applicable) contains the number of (nonderivative) shares underlying a derivative transaction. For example, in the exercise of options, this field contains the number of shares underlying the option exercise.

1. A method of determining whether a non-uniquely identified name substantially corresponds to a uniquely identified person, the method comprising:
accessing a source dataset of uniquely identified persons, the dataset comprising records comprising, for each uniquely identified person, a source name, a source unique identifier, a source date of birth, and a source address;
accessing a target dataset of non-uniquely identified persons, the dataset comprising records comprising, for each non-uniquely identified person, a target name, a target age, and a target age-date indicating an exact or approximate date of the target age; and
for a particular source person in the source dataset, and in accordance with the accessing, automatically determining whether the particular source person corresponds to a particular target person in the target dataset.

2. A method according to claim 1, wherein the automatically determining comprises matching a target identifier in the target dataset with an identifier of the particular source person when the identifier of the particular source person is available, whereby the uniquely identified particular person is determined to correspond to the particular target person.

3. A method according to claim 2, wherein the automatically determining further comprises matching the date of birth and name of the particular source person with the particular target person based on the name, the target age, and the target age-date of the particular target person, whereby the uniquely identified particular person is determined to correspond to the particular target person.

4. A method according to claim 3, wherein the automatically determining further comprises matching the address of the particular source person with the address of the particular target person, whereby the uniquely identified particular person is determined to correspond to the particular target person.

5. A method according to claim 4, wherein the automatically matching of addresses further comprises determining that the particular source person and the particular target person both have an address common to a set of current/previous addresses of the particular source person, where the set of current/previous addresses are obtained separately from and keyed to the source dataset.

6. A method according to claim 5, wherein the automatically determining further comprises determining a uniqueness of the source name of the particular source person, and based on the uniqueness, determining whether the source name corresponds to the target name of the particular target person.

7. A method according to claim 6, further comprising automatically finding one or more persons who have co-resided with the particular source person using another dataset.

8. A method according to claim 7, wherein the automatically finding of one or more persons who have co-resided with the particular person is based on whether the one or more persons have lived at the particular person's source address for a predetermined period of time, and is based on whether the one or more persons have lived at two consecutive current/previous addresses in the set of current/previous addresses of the particular source person.

9. A method according to any of claims 1 through 8, wherein the target dataset comprises a set of officers or directors of publicly traded companies, wherein the source dataset comprises a set of potential market participants, and wherein the determining of a correspondence between the particular source person and the particular target person indicates a substantial likelihood that the particular source person is a market participant that is also an officer or director of a publicly traded company.

10. A computer-implemented method of identifying a person, comprising:
given non-uniquely identified target names and target ages/addresses corresponding to target persons, and using a comprehensive public record dataset produced by combining multiple disparate public record databases of data of a general population including the target persons, automatically determining with substantial certainty that a target name corresponds with a particular unique individual in the general population, thereby identifying the person corresponding to the target name.

11. A method according to claim 10, wherein the determining is based only on the target name and target age/address.

12. A method according to claim 10, wherein the determining is done without a key or identifier uniquely identifying the target person among the general population and by using the public record dataset to link the target person to the particular individual in the general population.

13. A method according to claim 12, wherein the key or identifier comprises a social security number or an identifier that serves as a proxy therefor.

14. A method according to claim 10, wherein the determining is based on at least one of a date of birth of the particular individual, a degree of uniqueness of the target name, and a set of previous/former addresses of the particular individual.

15. A method according to any of claims 10 through 14, wherein the target persons comprise officers or directors of publicly traded companies.

16. A method according to claim 15, wherein the determining of a correspondence between the particular unique individual in the general population with the target name indicates a substantial likelihood that the particular unique individual is an officer or director of a publicly traded company.

17. An apparatus for determining whether a non-uniquely identified name substantially corresponds to a uniquely identified person, the apparatus comprising:
a first storage storing a source dataset of uniquely identified persons, the dataset comprising records comprising, for each uniquely identified person, a source name, a source unique identifier, a source date of birth, and a source address;
a second data storage storing a target dataset of non-uniquely identified persons, the dataset comprising records comprising, for each non-uniquely identified person, a target name, a target age, and a target age-date indicating an exact or approximate date of the target age; and
a processing unit, for a particular source person in the source dataset, and in accordance with the accessing, automatically determining whether the particular source person corresponds to a particular target person in the target dataset.
